(19) United States
(12) Patent Application Publication
(10) Pub. No.: US 2009/0119090 A1
(43) Pub. Date: May 7, 2009

(54) Principled Approach to Paraphrasing

(75) Inventors: Cheng Niu, Beijing (CN); Ming Zhou, Beijing (CN)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 11/934,010

(22) Filed: Nov. 1, 2007

(51) Int. Cl. G06F 17/20

(52) U.S. Cl. 704/1

(57) ABSTRACT

A principled approach to paraphrasing analyzes input text and paraphrases at atomic linguistic level, instead of analyzing the input text and paraphrases as a whole set at one time. The principled approach extracts atomic linguistic elements from the input text and identifies matching atomic paraphrasing elements to form candidate atomic paraphrasing pairs. A variety of atomic transformation types are identified to form atomic paraphrasing pairs. The candidate atomic paraphrasing pairs are evaluated using feature functions and a probability model. The principled approach scores a combination of multiple candidate atomic paraphrasing pairs using a score function which derives its value from the feature functions of the candidate atomic paraphrasing pairs. A combination which has a high score may be used for constructing a paraphrasing text.

### BACKGROUND

Paraphrasing used in a computerized environment is a process of automatically generating a paraphrasing sentence from a reference sentence or an input sentence. The computer-generated paraphrases are alternative ways of conveying the same information. Paraphrasing is an important natural language processing task which is targeted on rephrasing the same statement in many different ways, for example, transforming “John wrote the book” into “John is the author of the book”. Valuable application of paraphrasing includes information retrieval, information extraction, question answering and machine translation. For example, in the automatic evaluation of machine translation, paraphrases may help to alleviate problems presented by the fact that there are often alternative and equally valid ways of translating a text. In question answering, discovering paraphrased answers may provide additional evidence that an answer is correct.

In the last decade, intensive research attention from computation linguistic community has been paid to the field of paraphrase acquisition, including paraphrasing at lexical level, syntactic level and semantic level. Especially, statistical machine translation techniques (SMT) have been used to model paraphrasing as a monolingual translation task. However, the lack of the parallel corpora (i.e. sentences with their paraphrases) is the major knowledge bottleneck to effectively learn a paraphrasing model. To overcome such knowledge bottleneck, various approaches have been proposed, including identifying comparable sentences in the news covering the same topic, extracting parallel sentences from multiple translations of the same foreign novel, learning phrasal paraphrases from bilingual parallel corpora, and using named entities as anchor points to collect parallel sentences. Besides, an unsupervised context clustering has also been proposed to learn paraphrases based on dependency parsing results.

The existing techniques for paraphrasing regard paraphrases as a whole set, and use unified machine learning frameworks to model the paraphrasing transformations. Due to the limited size of training data and oversimplified modeling techniques, the existing unified approaches fail to learn the linguistic regularities underlying various types of paraphrases. This will result in both limited precision and high recall rate. Given the importance of automatic paraphrasing, especially in the context of natural language processing, it is desirable to discover new ways that may improve paraphrasing from various aspects.

### SUMMARY

This disclosure describes a principled approach to paraphrasing. The principled approach analyzes input text and constructs paraphrases at atomic linguistic level, instead of analyzing the input text and finding paraphrases as a whole set at one time. The principled approach extracts atomic linguistic elements from the input text and identifies matching atomic paraphrasing elements to form candidate atomic paraphrasing pairs. The candidate atomic paraphrasing pairs are evaluated using, for example, feature functions and a trained probability model. The principled approach scores a combination of multiple candidate atomic paraphrasing pairs using a score function which derives its value from the feature functions of the candidate atomic paraphrasing pairs. A combination which has a high score may be used for constructing a paraphrasing text.

In some embodiments, a variety of atomic transformation types are identified to form atomic paraphrasing pairs. The atomic transformations and appropriate feature functions are acquired and trained to build atomic paraphrasing models which are used for selecting and evaluating candidate atomic paraphrasing pairs, and for scoring various combinations of candidate atomic paraphrasing pairs. The principled approach to paraphrasing may be used in computerized automatic paraphrasing in various applications, including word processing and keyword-based searching.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE FIGURES

The detailed description is described with reference to the accompanying figures. In the figures, the left-most digit(s) of a reference number identifies the figure in which the reference number first appears. The use of the same reference numbers in different figures indicates similar or identical items.

FIG. 1 is a flowchart of an exemplary process of automatic paraphrasing using atomic paraphrases.

FIG. 2 shows an exemplary environment for implementing the atomic paraphrasing method of the present disclosure.

FIG. 3 is a list of fifteen exemplary paraphrasing transformation classes.

FIG. 4 is a flowchart of an exemplary process of acquiring semantically related lexicons using the algorithm of mutual induction for paraphrasing patterns and lexical relations.

### DETAILED DESCRIPTION

The present disclosure proposes a principled approach to sentential paraphrasing. This approach is based on the following observation: there exist many different classes of atomic paraphrasing transformation, and a paraphrase may be created using a combination of atomic paraphrasing transformations.

There are many different classes of paraphrase, and these different paraphrase classes may follow different linguistic patterns. As will be described in detail herein, fifteen major atomic paraphrasing classes are identified based on data exploration and analysis. Different paraphrasing pattern acquisition schemes are designed for different paraphrasing classes. For each class of atomic paraphrasing transformation, paraphrasing patterns are acquired by either machine learning or hand-crafted rules. In particular, an algorithm of mutual induction for paraphrasing patterns and lexical relations is introduced to learn atomic paraphrasing patterns. This algorithm is initiated with a list of pre-defined lexical pairs, and learns atomic paraphrasing patterns based on the lexical pair list. The learned patterns are then used to expand the lexical pair list which makes the learning a recursive procedure.

Exemplary parallel sentences are also collected using existing techniques and then used to train a paraphrasing model so it may be able to estimate the reliability of each atomic pattern. The final paraphrasing model is used to decide if an atomic pattern is triggered given a specific context of the input text.

With the final paraphrasing model built and trained, automatic paraphrasing can be performed using exemplary procedures described below. The order in which the procedure is described is not intended to be construed as a limitation, and any number of the described blocks may be combined in any order to implement the method, or an alternate method.

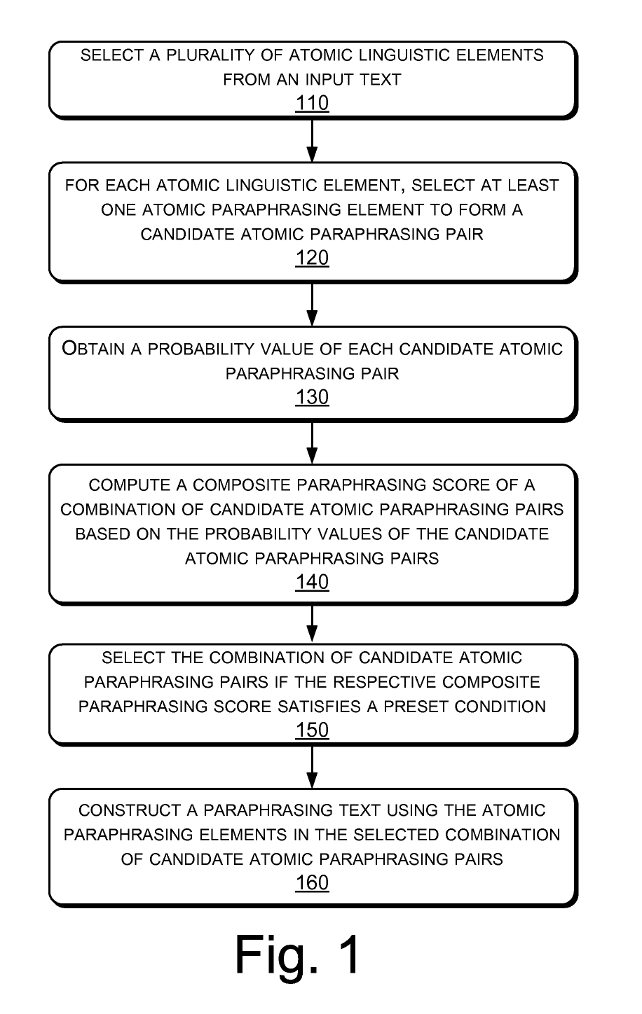

FIG. 1 is a flowchart of an exemplary process of automatic paraphrasing using the atomic paraphrases. At block 110, the process selects a plurality of atomic linguistic elements from an input text. The atomic linguistic elements may be extracted from the input text. As will be further described herein, the atomic linguistic elements have several kinds including a word, a phrase, a pattern and a lexical dependency tree. Each atomic linguistic element kind may be involved with multiple atomic linguistic elements. For example, among the plurality of atomic linguistic elements selected, one or more may be one atomic linguistic element kind, one or more may be another atomic linguistic element kind, and so on. The various kinds of atomic linguistic elements may be further classified into multiple classes.

At block 120, for each atomic linguistic element, the process selects one or more atomic paraphrasing elements. The atomic linguistic element relates to the selected atomic paraphrasing element through an atomic transformation to form a candidate atomic paraphrasing pair. The atomic paraphrasing element may be selected from a data source based on a probability model as described herein. The atomic transformations for candidate atomic paraphrasing pairs may also be defined and recognized by the data source.

As will be further described herein, the atomic transformations may be any one of multiple classes such as lexical substitution, active and passive exchange, reordering of sentence components, realization in different syntactic components, head omission, prepositional phrase attachment, change into different sentence types, morphological derivation, light verb construction, exchange of comparatives and superlatives, converse word substitution, verb nominalization, substitution using words with overlapping meanings, inference, and different somatic role realization.

At block 130, the process obtains a probability value of each candidate atomic paraphrasing pair. In one embodiment, the process obtains the probability value by computing a value of an appropriate feature function describing a probability of the atomic paraphrasing pair.

At block 140, the process computes a composite paraphrasing score of a combination of candidate atomic paraphrasing pairs based on the probability values of the candidate atomic paraphrasing pairs. The process may compute the composite paraphrasing score by computing a value of a score function. In one embodiment, the score function is a product of the appropriate feature functions of the candidate atomic paraphrasing pairs in the selected combination.

At block 150, the process selects a combination of candidate atomic paraphrasing pairs if its composite paraphrasing score satisfies a preset condition. In general, the process selects those combinations that have the highest composite paraphrasing scores. One or more combinations may be selected.

At block 160, the process constructs a paraphrasing text using the atomic paraphrasing elements in the selected combination of candidate atomic paraphrasing pairs.

The above paraphrasing techniques may be used in various applications. For example, the process may be incorporated in a word processor, in which the input text is generated by a user, and the paraphrasing text is output to the user as an alternative to the input text. This may be a useful add-on function in a word processor to assist the user's writing by suggesting alternative ways of expressing a certain idea. The process may also be incorporated in a language learning program, especially for language learning program, in which paraphrases may be provided to teach the user alternative ways of expressing a certain idea. The process may also be incorporated in a search engine, in which the input text is generated by a user as a search query, and the paraphrasing text is used by the search engine as an alternative search query. Alternatively, the process may be incorporated in a search engine, in which the input text is provided by a data source (such as a Web data source) as a search object, and the paraphrasing text is used by the search engine as an alternative search object to match the user search query.

### Implementation Environment

The above-described process may be implemented with the help of a computing device, such as a server, a personal computer (PC) or a portable device having a computing unit.

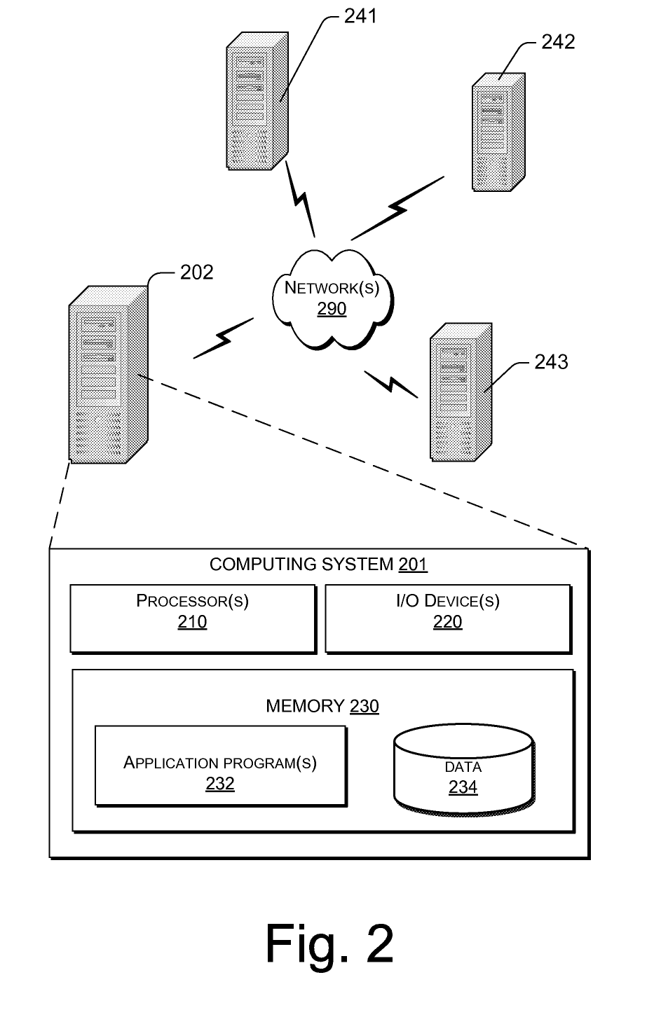

FIG. 2 shows an exemplary environment for implementing the method of the present disclosure. Computing system 201 is implemented with computing device 202 which includes processor(s) 210, I/O devices 220, computer readable media (e.g., memory) 230, and network interface (not shown). The computer readable media 230 stores application program modules 232 and data 234 (such as paraphrasing data). Application program modules 232 contain instructions which, when executed by processor(s) 210, cause the processor(s) 210 to perform actions of a process described herein (e.g., the processes of FIGS. 1-4). For example, in one embodiment, computer readable medium 230 has stored thereupon a plurality of instructions (e.g. instructions in application programs 232) that, when executed by one or more processors 210, causes the processor(s) 210 to:

(a) select a plurality of atomic linguistic elements from an input text, wherein the plurality of atomic linguistic elements includes at least one atomic linguistic element kind selected from a word, a phrase, a pattern and a lexical dependency tree;

(b) identify a plurality of candidate atomic paraphrasing pairs each having one of the plurality of atomic linguistic elements and an atomic paraphrasing element;

(c) select a combination of candidate atomic paraphrasing pairs; and

(d) construct a paraphrasing text of the input text using the atomic paraphrasing elements in the selected combination of candidate atomic paraphrasing pairs.

In one embodiment, the process is implemented for a local user (not shown) using computing device 202. The input text may be generated by the local user on computing device 202. The processor(s) 210 presents the constructed paraphrasing text to the local user at computing device 202. In other embodiments, the process may be implemented for network searches via network(s) 290, in which a user at computing device 202 searches data sources located on networked computing devices (such as servers) 241, 242 and 243. Computing device 202 may contain a search engine (not shown). The input text is either generated by a user as a search query or provided as a search object by a data source on the networked computing devices 241, 242 and 243, while the paraphrasing text is either used by the search engine as an alternative search query or used by the search engine as an alternative search object.

The above-described atomic paraphrasing method uses an atomic paraphrasing model which can be built and trained before placed into the final application. The following describes the detail of building and training such an atomic paraphrasing model.

### Building and Training an Atomic Paraphrasing Model

The sentential paraphrasing task can be formulated as one to find a score function SC(S_{OUT}, S_{IN}) such that given an input sentence S_{IN}, the true paraphrasing sentences denoted by {S_{OUT}} are always ranked as the top by SC (S_{OUT}, S_{IN}).

It is assumed that any paraphrase is generated by a combination of several atomic paraphrasing transformations {AT}. Furthermore, a set of feature functions {F (AT, S_{IN})} are defined. Finally, SC (S_{OUT}, S_{IN}) is represented as a log linear function of the features being involved, as expressed as follows:

SC(S_{OUT},S_{IN})=π_{i,j}exp((Fⱼ(ATᵢ,S_{IN})*wⱼ)) (1)

Where {ATᵢ} are the atomic paraphrasing transformations converting S_{IN} into S_{OUT}, and {wⱼ} are the weights associated with the feature functions.

The task of building a paraphrasing model is divided into three subtasks:

(i) learn the atomic paraphrasing transformations {AT};

(ii) design features functions {F(AT, S_{IN})}; and

(iii) estimate weights {w}.

The above subtasks are described in the following.

### Learning Atomic Paraphrasing Transformations and Designing Feature Functions:

Sentential paraphrasing may occur at three different levels, which are lexical level, syntactic level, and semantic level. Lexical level paraphrasing refers to synonym substitution, word deletion and insertion. Syntactic paraphrasing refers to grammatical transformations of the input sentence, and does not involve any changes of the content words. Semantic paraphrasing refers to non-decomposable combination of lexical substitution and syntactic variation. The present atomic paraphrasing method recognizes multiple major paraphrasing transformation classes in each of these levels.

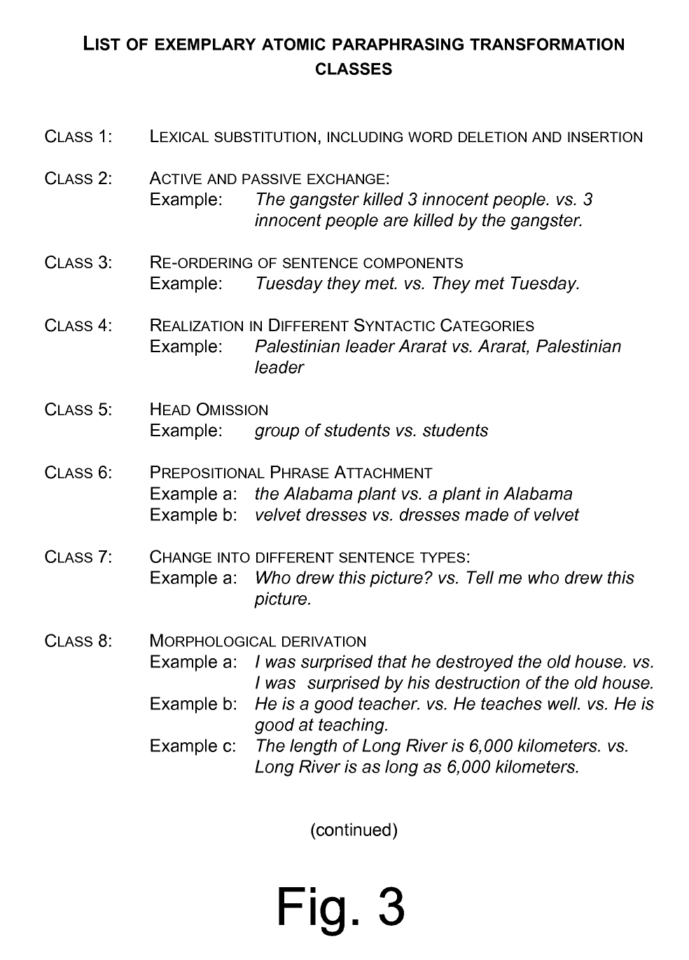

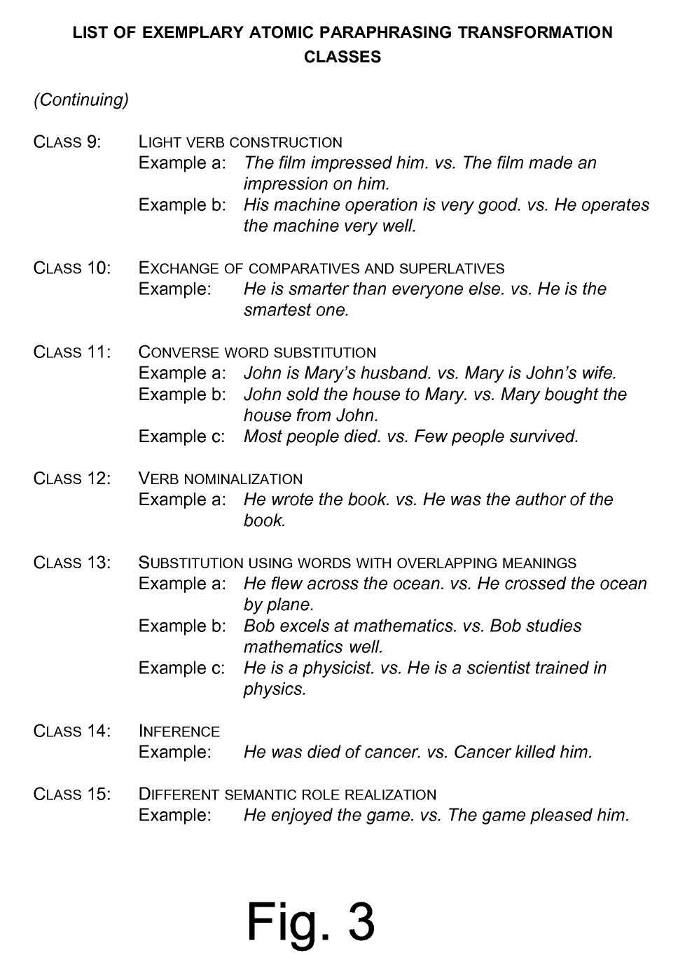

FIG. 3 is a list of fifteen exemplary paraphrasing transformation classes. These include the following with the examples:

Class 1: Lexical substitution, including word deletion and insertion

Class 2: Active and passive exchange
The gangster killed 3 innocent people. vs. 3 innocent people are killed by the gangster.

Class 3: Re-ordering of sentence components
Tuesday they met. vs. They met Tuesday.

Class 4: Realization in different syntactic categories
Palestinian leader Ararat vs. Ararat, Palestinian leader

Class 5: Head omission
group of students vs. students

Class 6: Prepositional phrase attachment
the Alabama plant vs. a plant in Alabama
velvet dresses vs. dresses made of velvet

Class 7: Change into different sentence types
Who drew this picture? vs. Tell me who drew this picture.

Class 8: Morphological derivation
I was surprised that he destroyed the old house. vs. I was surprised by his destruction of the old house.
He is a good teacher. vs. He teaches well. vs. He is good at teaching.
The length of Long River is 6,000 kilometers. vs. Long River is as long as 6,000 kilometers.

Class 9: Light verb construction
The film impressed him. vs. The film made an impression on him.
His machine operation is very good. vs. He operates the machine very well.

Class 10: Comparatives vs. superlatives
He is smarter than everyone else. vs. He is the smartest one.

Class 11: Converse word substitution
John is Mary's husband. vs. Mary is John's wife.
John sold the house to Mary. vs. Mary bought the house from John.
Most people died. vs. Few people survived.

Class 12: Verb nominalization
He wrote the book. vs. He was the author of the book.

Class 13: Substitution using words with overlapping meanings
He flew across the ocean. vs. He crossed the ocean by plane.
Bob excels at mathematics. vs. Bob studies mathematics well.
He is a physicist. vs. He is a scientist trained in physics.

Class 14: Inference
He was died of cancer. vs. Cancer killed him.

Class 15: Different semantic role realization
a. He enjoyed the game. vs. The game pleased him.

The above class 1 belongs to lexical level paraphrasing, classes 2-7 belong to syntactic level paraphrasing, and class 8-15 belong to semantic level paraphrasing. Based on these exemplary atomic paraphrasing transformation classes, paraphrasing patterns can be acquired and feature functions can be designed.

The acquisition of the paraphrasing patterns and the design of the feature functions for each class are described in the following. The detailed algorithm description below introduces several notations. Freq(w) refers to the frequency of word w in a large corpora, and cos({w}), {v}) refers to the tf-idf (term frequency-inverse document frequency weight) based cosine similarity between context {w} and {v}.

Class 1: Exemplary pattern learning and feature design for class 1 atomic paraphrasing transformation is described below.

The class (1) atomic paraphrasing transformation is lexical substitution such as substitution of synonyms but also includes word deletion and insertion. In the class 1 atomic paraphrasing transformation, the atomic linguistic element may either be a word w₁ or a phrase pₕ₁, and a corresponding atomic paraphrasing element may either be another word w₂ (typically a synonym of the word w₁ or phrase pₕ₁) or another phrase ph₂ (typically a synonymous phrase of the phrase ph₁ or word w₁). Many methods may be used to learn synonyms and synonymous phrases. The following are three exemplary methods used to learn synonyms.

(i) Word clustering algorithm: Word similarity sim(w₁, w₂) can be estimated between each pair of words, and any word pair with the similarity higher than a pre-defined threshold θ₁ can be regarded as a synonym. The corresponding paraphrasing transformation is denoted as {w₁→w₂}_{ws}. Three feature functions are defined accordingly:

$$\begin{matrix}{F}_{1} ( AT , {S}_{IN} ) = \{ \begin{matrix}sim ( {w}_{1} , {w}_{2} ) , & if AT can be represented as {\{ {w}_{1} -> {w}_{2} \}}_{WS} \\ 0 , & otherwise\end{matrix} & ( 2 ) \\ {F}_{2} ( AT , {S}_{IN} ) = \{ \begin{matrix}Freq ( {w}_{1} ) Freq ( {w}_{2} ) , & if AT can be represented as {\{ {w}_{1} -> {w}_{2} \}}_{WS} \\ 0 , & otherwise\end{matrix} & ( 3 ) \\ {F}_{3} ( AT , {S}_{IN} ) = \{ \begin{matrix}cos ( {common}_{WS} ( {w}_{1} , {w}_{2} ) , {S}_{IN} ) , & if AT can be represented as {\{ {w}_{1} -> {w}_{2} \}}_{WS} \\ 0 , & otherwise\end{matrix} & ( 4 )\end{matrix}$$

where common_{ws} (w₁, w₂) refers to the common context words when estimating sim(w₁, w₂). The above feature function F₁ is used to estimate the similarity between the two words; F₂ is used to estimate the reliability of the word similarity measure based on the assumption that word similarity measure is more reliable for frequently occurring word pairs; and F₃ is used to check if the synonym substitution matches the context of the given input sentence.

(ii) Learning phrase (i.e. a sequence of words) substitutions from bilingual parallel corpora: Phrasal paraphrase can be derived from bilingual parallel corpora based on the observation that if two English phrases can be translated into the same phrase of a foreign language, the two English phrases are probably paraphrases. An exemplary learning procedure is described as follows. It is noted that a word is a special case of a phrase.

First, given bilingual parallel corpora, word alignment is performed using GIZA++method for training of statistical translation models, as described on the webpage http://www.fjoch.com/GIZA++.html. Phrase translation pairs are then extracted, and the translation probability P_{T}(ph_{f}|phₑ) for each bilingual phrase pair ph_{f} (phrase in foreign language) and phₑ (phrase in English) is estimated. Finally, the paraphrasing equivalence probability between two phrases in English phₑ and phₑ′ is defined as:

P_{ph,B}(phₑ′|phₑ)=Σₚₕ_{_{f}}P_{T}(phₑ′|ph_{f})P_{T}(ph_{f}|phₑ).

A phrasal substitution with probability P_{ph,B}(phₑ′|phₑ) higher than a threshold θ₂ may be regarded as a valid paraphrasing transformation. Referring the two phrases in English phₑ and phₑ′ as ph₁ and ph₂, respectively, the paraphrasing transformation is denoted as {ph₁→ph₂}_{BP}. The following three feature functions are defined accordingly.

$$\begin{matrix}{F}_{4} ( AT , {S}_{IN} ) = \{ \begin{matrix}{p}_{p h , B} ( p {h}_{1} \vert p {h}_{2} ) , & if AT can be represented as {\{ p {h}_{1} -> p {h}_{2} \}}_{BP} \\ 0 , & otherwise\end{matrix} & ( 5 ) \\ {F}_{5} ( AT , {S}_{IN} ) = \{ \begin{matrix}Freq ( p {h}_{1} ) Freq ( p {h}_{2} ) , & if AT can be represented as {\{ p {h}_{1} -> p {h}_{2} \}}_{BP} \\ 0 , & otherwise\end{matrix} & ( 6 ) \\ {F}_{6} ( AT , {S}_{IN} ) = \{ \begin{matrix}cos ( {common}_{BP} ( p {h}_{1} , p {h}_{2} ) , {S}_{IN} ) , & if AT can be represented as {\{ p {h}_{1} -> p {h}_{2} \}}_{BP} \\ 0 , & otherwise\end{matrix} & ( 7 )\end{matrix}$$

where common_{BP} (ph₁, ph₂) refers to the common context words when phrases ph₁ and ph₂ are translated into the same phrases of a different language.

(iii) Learning phrasal substitution from monolingual parallel corpora: Monolingual parallel corpora may be collected either from comparable news or from multiple translations of the same foreign novels. Using the collected monolingual parallel corpora, sentence alignment can be performed to extract monolingual parallel sentence pairs. Similar to bilingual parallel corpora processing, word alignment and phrase translation pair extraction are performed to learn the phrasal substitution probability (i.e. monolingual translation probability) P_{ph,M}(ph₂|ph₁). A phrasal pairs with P_{ph,M}(ph₂|ph₁) higher than a threshold θ₃ may be regarded as a phrasal substitution candidate. The corresponding paraphrasing transformation is represented as {ph₁→ph₁}_{MP}. Accordingly, three feature functions are defined as follows:

$$\begin{matrix}{F}_{7} ( AT , {S}_{IN} ) = \{ \begin{matrix}{p}_{p h , M} ( p {h}_{1} \vert p {h}_{2} ) , & if AT can be represented as {\{ p {h}_{1} -> p {h}_{2} \}}_{MP} \\ 0 , & otherwise\end{matrix} & ( 8 ) \\ {F}_{8} ( AT , {S}_{IN} ) = \{ \begin{matrix}Freq ( p {h}_{1} , p {h}_{2} ) , & if AT can be represented as {\{ p {h}_{1} -> p {h}_{2} \}}_{MP} \\ 0 , & otherwise\end{matrix} & ( 9 ) \\ {F}_{9} ( AT , {S}_{IN} ) = \{ \begin{matrix}cos ( {common}_{MP} ( p {h}_{1} , p {h}_{2} ) , {S}_{IN} ) , & if AT can be represented as {\{ p {h}_{1} -> p {h}_{2} \}}_{MP} \\ 0 , & otherwise\end{matrix} & ( 10 )\end{matrix}$$

where common_{BP} (ph₁, ph₂) refers to the common context words when ph₁ and ph₂ are aligned together in the monolingual parallel corpora.

Classes 2-4: The following describes exemplary pattern learning and feature design for classes 2-4.

Classes 2-4 of atomic paraphrasing transformation are active and passive exchange, reordering of sentence components, and realization in different syntactic categories, respectively. Paraphrasing of classes 2-4 mainly involves word re-ordering following a set of syntactic patterns. In the classes 2-4 of atomic paraphrasing transformations, the atomic linguistic element may be a dependency tree Treeᵢₙ, while a corresponding atomic paraphrasing element may be another dependency tree Treeₒᵤₜ. In one embodiment, the paraphrasing of classes 2-4 is modeled as a two step procedure: (i) transform dependency tree of the original sentence into a new dependency tree; and (ii) generate paraphrased sentences using the new dependency tree.

A number of sample paraphrasing instances of classes 2-4 may be provided to learn the dependency tree transformation rules and tree-based sentence generation model. An exemplary learning procedure is given as follows:

(a) perform word alignment between original and paraphrased sentences provided in the sample paraphrasing instances;

(b) parse the sentences (both the original and the paraphrased ones) by a dependency parser;

(c) learn transformation rules between dependency trees; and

(d) learn the sentence generation model given a dependency tree.

The above steps (a)-(c) may use only a relatively small number (e.g., 1,000) of human annotated sentence pairs, while the modeling of sentence generation of step (d) can make use of any large monolingual corpora and not limited to the sentence pairs used in the above steps (a)-(c). One embodiment implements the tree transformation rule learning algorithm and dependency tree based sentence generation algorithm described in Chris Quirk, Arul Menezes, and Colin Cherry, 2004 (Dependency Tree Translation: Syntactically Informed Phrasal SMT, Microsoft Research Technical Report: MSR-TR-2004-113). That sentence generation algorithm estimates tree transformation probabilities Pr (Tree₂|Tree₁) and sentence generation probability Pr(S_{OUT}|Tree). Accordingly, the atomic paraphrasing transformation is denoted as {Treeᵢₙ→Treeₒᵤₜ→S_{OUT}}_{ST}, and two additional feature functions are designed:

$$\begin{matrix}{F}_{10} ( AT , {S}_{IN} ) = \{ \begin{matrix}Pr ( {Tree}_{out} \vert {Tree}_{1} ) , & if AT can be represented as {\{ {Tree}_{1} -> {Tree}_{out} -> {S}_{OUT} \}}_{ST} \\ 0 , & otherwise\end{matrix} & ( 11 ) \\ {F}_{11} ( AT , {S}_{IN} ) = \{ \begin{matrix}Pr ( {S}_{out} \vert {Tree}_{out} ) , & if AT can be represented as {\{ {Tree}_{1} -> {Tree}_{out} -> {S}_{OUT} \}}_{ST} \\ 0 , & otherwise\end{matrix} & ( 12 )\end{matrix}$$

Class 5: The following describes human-crafted rules for class 5.

Class 5 of atomic paraphrasing transformation is head omission. In this class, the atomic linguistic element may be a phrase X of Y (as in “group of students”) and a corresponding atomic paraphrasing element may be the word Y only; or vice versa. Human-crafted rules may be used to deal with the paraphrasing of class 5. In one embodiment, the rule development involves two steps: (i) manually collect lexicons {Xᵢ} such as group, majority, many, etc., which frequently occur in the pattern X of noun, and can be neglected by the paraphrasing transformation of head omission; and (ii) automatically collect lexicons {Yⱼ} which occur frequently in the pattern Xᵢ of Yⱼ, where Yⱼ is associated with the part-of-speech tag of noun, and Xᵢ is a one of the lexicon collected in step (i). A paraphrasing transformation pattern {X of Y [symbol] Y} is then generated. Accordingly, the following feature function is defined:

$${F}_{12} ( AT , {S}_{IN} ) = \{ \begin{matrix}1 , AT belongs to Class 5 \\ 0 , otherwise\end{matrix} . \qquad ( 13 )$$

Class 6: The following describes exemplary lexicon acquisition for class 6.

The class 6 atomic paraphrasing transformation is pre-positional phrase attachment. In this class, the atomic linguistic element may be a pattern X+noun (as seen “velvet dresses”), and a corresponding atomic paraphrasing element may be another pattern noun+Y (as in “dresses made of velvet”), where X is a word and Y is a word sequence (phrase). Various methods may be used to collect such patterns and words, and word sequences (phrases) involved in the patterns.

One embodiment automatically collects lexicons {Xᵢ} and word sequences {Yᵢ}, where Yᵢ is the most frequent prepositional phrase using Xᵢ as the leading word {Xᵢ}. Accordingly, a feature function is defined as follows:

$${F}_{13} ( AT , {S}_{IN} ) = \{ \begin{matrix}1 , if AT belongs to Class 6 \\ 0 , otherwise\end{matrix} \qquad ( 14 )$$

The lexicons {Xᵢ} and {Yᵢ} may also be learned from a large monolingual corpora by using the following two patterns: (i) Xᵢ is followed by Z which is a noun; and (ii) Z, which is noun, is followed by Yᵢ. Here, the set of words {Z} for Xᵢ (or Yᵢ) is denoted by Z(Xᵢ) (or Z(Yᵢ)), the occurrence amount of the pattern Xᵢ followed by a Z is denoted as freq(Xᵢ, Z), and the occurrence amount of the pattern Z followed by Yᵢ is denoted by freq(Yᵢ, Z). A transformation Xᵢ+noun [symbol] noun+Yᵢ is then recognized as a valid paraphrasing transformation if E_{ZεZ(X}_{ᵢ}₎ max(freq(Xᵢ, Z)−C, 0)max(freq(Xᵢ, Z)−C, 0) is higher than a threshold (where C is a constant). Accordingly, two feature functions are defined as follows:

$$\begin{matrix}{F}_{14} ( AT , {S}_{IN} ) = \{ \begin{matrix}{\sum }_{z ∈ Z ( {X}_{1} )} max ( freq ( {X}_{i} , Z ) - C , 0 ) max ( freq ( {X}_{i} , Z ) - C , 0 ) , & if AT is \{ {X}_{i} + noun -> noun + {Y}_{i} \} \\ 0 , & otherwise\end{matrix} & ( 15 ) \\ {F}_{15} ( AT , {S}_{IN} ) = \{ \begin{matrix}sim ( common ( Z ( {X}_{i} ) , Z ( {Y}_{i} ) ) , {S}_{IN} ) , & if AT si \{ {X}_{i} + noun -> noun + {Y}_{i} \} \\ 0 , & otherwise\end{matrix} & ( 16 )\end{matrix}$$

The above feature function F₁₄ is used to estimate the reliability of the paraphrasing transformation, while feature function F₁₅ is used to check if the transformation matches the context of the given input sentence.

Class 7: The following describes exemplary methods for acquiring and learning class 7 atomic paraphrasing transformations.

The paraphrasing transformation of Class 7 involves change into different sentence types. In this class, both the atomic linguistic element and corresponding atomic paraphrasing element are patterns. Class 7 usually involves only close set of patterns, which can either be learned or handled easily by human-crafted rules. The following feature function is defined for Class 7:

$${F}_{16} ( AT , {S}_{IN} ) = \{ \begin{matrix}1 , AT belongs to Class 7 \\ 0 , otherwise\end{matrix} . \qquad ( 17 )$$

Class 8-9: The following describes exemplary methods for acquiring and learning class 8-9 atomic paraphrasing transformations.

Both Classes (8) and (9) involve morphological variations. In these two classes, both the atomic linguistic element and corresponding atomic paraphrasing element may be dependency trees. In one embodiment, the morphological variations are handled by the following exemplary procedure.

(a) Generate three sets of lexical pairs, including a verb and its nominalization (e.g., teach and teaching), a verb and an actor who initiates the action (e.g., teach and teacher), a noun and its adjective attribute (e.g., length and long), from a lexicon such as WordNet.

(b) Provide a collection of sample parallel sentence pairs involving the above three sets of lexicon pairs.

(c) Perform word alignment between parallel sentence pairs.

(d) Learn dependency tree transformation patterns based on the word alignment.

(e) Learn a language generation model based on a given dependency tree.

The steps (b)-(e) may only use a relatively small collection of human annotated sentence pairs (e.g., 1,000 pairs). The modeling of sentence generation of step (e), however, may preferably make use of a large monolingual corpora, and is not limited to the smaller collection of human annotated sentence pairs. One embodiment implements dependency trees and the algorithm for learning tree transformation rules based sentence generation algorithm as disclosed in Chris Quirk, Arul Menezes, and Colin Cherry, 2004 (Dependency Tree Translation: Syntactically Informed Phrasal SMT, Microsoft Research Technical Report: MSR-TR-2004-113). The algorithm estimates tree transformation probabilities Pr(Tree₂|Tree₁) and sentence generation probability Pr(S_{OUT}|Tree), where Tree₁ is a dependency tree of the input text, and Tree₂ is a dependency tree of a potential output paraphrasing text. The sentence generation probability Pr(S_{OUT}|Tree) estimates the probability that a valid sentence may be generated from a candidate dependency tree Tree₂. Accordingly, the atomic paraphrasing transformation is denoted as {Treeᵢₙ→Treeₒᵤₜ→S_{OUT}}_{MV}, and two additional feature functions are designed:

$$\begin{matrix}{F}_{17} ( AT , {S}_{IN} ) = \{ \begin{matrix}Pr ( {Tree}_{out} \vert {Tree}_{1} ) , & if AT can be represented as {\{ {Tree}_{1} -> {Tree}_{out} -> {S}_{OUT} \}}_{MV} \\ 0 , & otherwise\end{matrix} & ( 18 ) \\ {F}_{18} ( AT , {S}_{IN} ) = \{ \begin{matrix}Pr ( {S}_{out} \vert {Tree}_{out} ) , & if AT can be represented as {\{ {Tree}_{1} -> {Tree}_{out} -> {S}_{OUT} \}}_{MV} \\ 0 , & otherwise\end{matrix} & ( 19 )\end{matrix}$$

Class 10: The paraphrasing transformation of Class 10 involves only close set of patterns, and can be handled by human-crafted rules. The following feature function is defined for Class (10):

$${F}_{19} ( AT , {S}_{IN} ) = \{ \begin{matrix}1 , AT belongs to Class 10 \\ 0 , otherwise\end{matrix} . \qquad ( 20 )$$

Classes 11-15: The following describes exemplary methods for acquiring and learning class 11-15 atomic paraphrasing transformations.

Paraphrasing of classes 11-15 involves acquisition of semantically related lexicons. Both the atomic linguistic element and corresponding atomic paraphrasing element are patterns that may be learned. One embodiment proposes a unique mutual induction algorithm to learn atomic paraphrasing patterns and lexical relations of classes 11-15. The algorithm is called “Mutual Induction for Paraphrasing Patterns and Lexical Relations”. This algorithm is initiated with a list of pre-defined lexical pairs, and learns atomic paraphrasing patterns based on the lexical pair list. The learned patterns are then used to expand the lexical pair list, making the learning a recursive procedure.

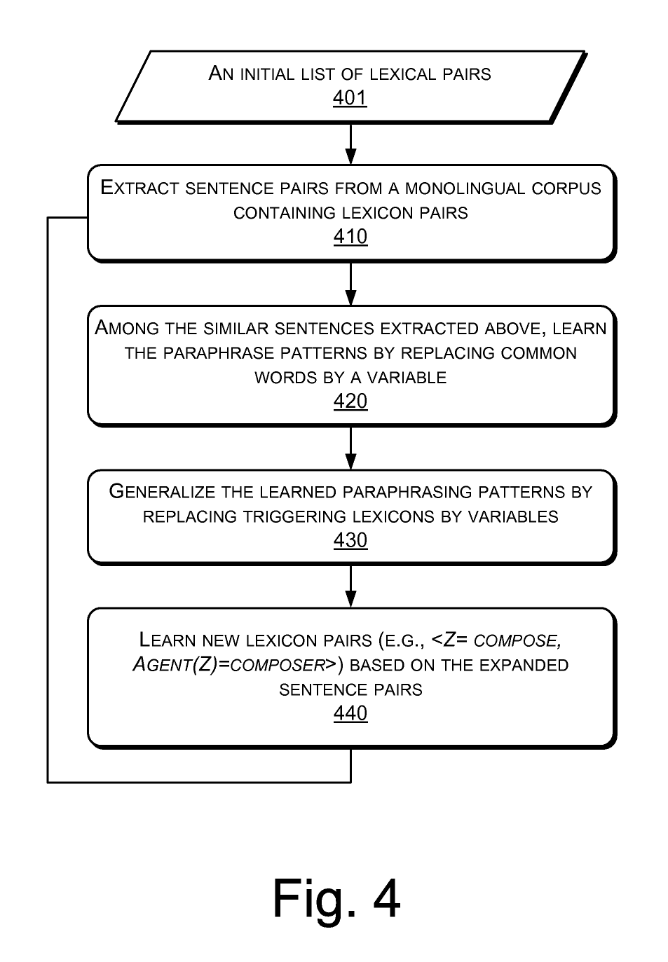

FIG. 4 is a flowchart of an exemplary process of acquiring semantically related lexicons using the algorithm of mutual induction for paraphrasing patterns and lexical relations.

At blocking 401, for each of the above five paraphrasing classes 11-15, an initial list of lexicon pairs is provided which trigger the following recursive learning procedure.

Block 410 extracts sentence pairs from a large monolingual corpus containing lexicon pairs. To be included in the extraction, the similarity of the sentence pairs should meet a preset condition, e.g., a pre-defined threshold. For example, based on the lexicon pair write and author, the following two sentences are extracted: Hemingway wrote <Old Man and the Sea>; and The author of <Old Man and the Sea> is Hemingway.

Block 420 learns among the similar sentences extracted above paraphrase patterns by replacing common words by a variable. For instance, with the above two exemplary sentences, the following paraphrasing patterns are learned: X write Y<-> the author of Y is X, where X write Y is learned as an atomic linguistic element, while the author of Y is X is learned as an atomic paraphrasing element, or vice versa. The learned paraphrasing patterns are ranked based on their occurrence frequency which is denoted as supp (AT). Preferably, only the patterns with top supp (AT) are kept.

Block 430 generalizes the learned paraphrasing patterns by replacing triggering lexicons by variables. For example, the pattern X write Y<-> the author of Y is X may be generalized into X Z Y<-> the Agent(Z) of Y is X, where Z is a variable verb. The resulting generalized patterns are then used to extract more similar sentence pairs from the monolingual corpora. For example, the following two additional exemplary sentences are extracted because they fit the generalized pattern: Beethoven composed Symphonie No. 9. vs. The composer of Symphonie No. 9 was Beethoven.

Block 440 learns new lexicon pairs (e.g., <Z=compose, Agent(Z)=composer>) based on the expanded sentence pairs. The generalization thus results in more paraphrasing patterns and more atomic linguistic elements and matching atomic paraphrasing elements.

The above process may be repeated from block 510 for further learning and expansion.

Accordingly, the following feature functions are defined for atomic paraphrasing transformation classes (11)-(15):

$$\begin{matrix}{F}_{20} ( AT , {S}_{IN} ) = \{ \begin{matrix}1 , & if AT belongs to Class 11 \text{-} 15 \\ 0 , & otherwise\end{matrix} & ( 21 ) \\ {F}_{21} ( AT , {S}_{IN} ) = \{ \begin{matrix}{n}_{lex } ( AT ) , & if AT belongs to Class 11 \text{-} 15 \\ 0 , & otherwise\end{matrix} & ( 22 ) \\ {F}_{22} ( AT , {S}_{IN} ) = \{ \begin{matrix}supp ( AT ) , & if AT belongs to Class 11 \text{-} 15 \\ 0 , & otherwise\end{matrix} & ( 23 )\end{matrix}$$

where nₗₑₓ(AT) is the iteration number in which the involved lexicon pair is learned.

### Log Linear Model Learning to Combine Atomic Paraphrasing Transformations:

Using the above-defined multiple atomic paraphrasing transformations, a paraphrasing model may be built which contains a large number of atomic linguistic elements and potential matching atomic paraphrasing elements. The information of the atomic linguistic elements and atomic paraphrasing elements, together with the statistical data of probabilities of the feature functions, can be stored in the system (e.g., stored as data 234 in memory 230 of FIG. 2). In addition, sample parallel sentence pairs which may contain one or more atomic linguistic elements may also be stored in the system to further assist the application of the paraphrasing model. For example, a large number (e.g., in millions) of monolingual parallel sentence pairs may be extracted from comparable news and multiple translations of the same novels. The parallel sentence pairs which can be converted from one to the other using the above fifteen atomic paraphrasing transformation classes are collected and stored in the atomic paraphrasing model. The parallel sentence pairs which cannot be converted from the one to the other by using the above fifteen atomic paraphrasing classes will be filtered out. The collected sentence pairs are associated with one or more feature functions defined above.

Finally, a perceptron algorithm disclosed in Jun'ichi Kazama and Kentaro Torisawa, 2007 (A New Perceptron Algorithm for Sequence Labeling with Non-local Features, In Proceedings of EMNLP 2007) maybe used to learn the weights in Equation (1). This completes the building and training of the paraphrasing model. The final paraphrasing model may be then incorporated in a paraphrasing program for application.

According to one aspect of the present atomic paraphrasing technique, multiple atomic paraphrasing pairs each having atomic linguistic element and a matching atomic paraphrasing element are identified and evaluated using individual feature functions described above that are compatible with the respective atomic paraphrasing pair. For a given input text, the various atomic paraphrasing pairs define a multidimensional space in which a combination of several atomic paraphrasing pairs constitutes a vector. Numerous combinations may exist for a given set of atomic paraphrasing pairs. Each combination defines a set of atomic paraphrasing elements which together may be used to construct a paraphrasing text of the input text. The score function SC (S_{OUT}, S_{IN}) is used for computing a composite paraphrases score of each candidate combination. The combinations that score sufficiently high may be selected for constructing candidate paraphrasing texts.

In practice, the multi-dimensional space defined by all available atomic paraphrasing pairs may result in an exceedingly large number of combinations of atomic paraphrasing pairs, making the computation prohibitively expensive. To overcome this problem, individual atomic paraphrasing pairs may be evaluated first using appropriate feature functions to filter out those paraphrasing pairs that score to low. In addition, for a given set of candidate atomic paraphrasing pairs, adaptive and dynamic methods may be used to leave out at any point of the process combinations that are unlikely to score sufficiently high, and to perform full computation of the score function of only a small fraction of all possible combinations.

Referring back to FIG. 1, the process of automatic paraphrasing may use a paraphrasing program which incorporates a paraphrasing model built and trained as described above. In each specific instance of paraphrasing application on an input text, usually some but not all of the above defined feature functions are applicable. On the other hand, it is appreciated that for each candidate atomic paraphrasing pair, multiple feature functions may be applied to evaluate the probability of a candidate atomic paraphrasing pair, as long as the atomic paraphrasing model has suitable data for such evaluation, and the candidate atomic paraphrasing pair is compatible with the feature functions as defined herein. A candidate atomic paraphrasing pair which scores high in multiple feature functions indicates an enhanced probability, which is reflected in Equation (1) in which the product of multiple high values of feature functions resulted in a higher composite paraphrases score.

The atomic paraphrasing techniques disclosed herein analyze and construct paraphrases using a principled approach based on a multiclass atomic paraphrasing model. The techniques potentially overcome some of the basic problems existing in the conventional paraphrasing techniques. It is, however, appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for automatic paraphrasing, the method comprising:
selecting a plurality of atomic linguistic elements from an input text, the plurality of atomic linguistic elements including at least one atomic linguistic element kind selected from a word, a phrase, a pattern and a lexical dependency tree;
identifying a plurality of candidate atomic paraphrasing pairs each having one of the plurality of atomic linguistic elements and an atomic paraphrasing element;
selecting a combination of candidate atomic paraphrasing pairs; and
constructing a paraphrasing text of the input text using the atomic paraphrasing elements in the selected combination of candidate atomic paraphrasing pairs.

2. The method as recited in claim 1, wherein selecting the plurality of atomic linguistic elements comprises extracting atomic linguistic elements from the input text.

3. The method as recited in claim 1, wherein the at least one atomic linguistic element kind has multiple atomic linguistic elements.

4. The method as recited in claim 1, wherein identifying the plurality of candidate atomic paraphrasing pairs comprises:
for each atomic linguistic element, selecting at least one atomic paraphrasing element from a data source based on a probability model, wherein the atomic linguistic element relates to the selected at least one atomic paraphrasing element through an atomic transformation recognized by the data source.

5. The method as recited in claim 1, wherein the atomic linguistic element of each candidate atomic paraphrasing pair relates to the respective atomic paraphrasing element through an atomic transformation selected from a group consisted of lexical substitution, active and passive exchange, reordering of sentence components, realization in different syntactic components, head omission, prepositional phrase attachment, change into different sentence types, morphological derivation, light verb construction, exchange of comparatives and superlatives, converse word substitution, verb nominalization, substitution using words with overlapping meanings, inference, and different somatic role realization.

6. The method as recited in claim 1, wherein selecting the combination of candidate atomic paraphrasing pairs comprises:
for each atomic paraphrasing pair, obtaining a value of an appropriate feature function describing a probability of the atomic paraphrasing pair;
for each combination of candidate atomic paraphrasing pairs, computing a composite paraphrasing score based on the values of feature functions of the atomic paraphrasing pairs in the respective combination; and
selecting the combination of candidate atomic paraphrasing pair based on the composite paraphrasing score.

7. The method as recited in claim 1, further comprising:
forming a plurality of combinations of candidate atomic paraphrasing pairs; and
computing a composite paraphrasing score of each combination of candidate atomic paraphrasing pair, the composite paraphrasing score being used as a basis for selecting the combination of candidate atomic paraphrasing pairs used for constructing the paraphrasing text of the input text.

8. The method as recited in claim 1, wherein the method is incorporated in a word processor, the input text being generated by a user, and the paraphrasing text being output to the user as an alternative to the input text.

9. The method as recited in claim 1, wherein the method is incorporated in a search engine, the input text being generated by a user as a search query, and the paraphrasing text being used by the search engine as an alternative search query.

10. The method as recited in claim 1, wherein the method is incorporated in a search engine, the input text being provided by a data source as a search object, and the paraphrasing text being used by the search engine as an alternative search object.

11. A method for automatic paraphrasing, the method comprising:
selecting a plurality of atomic linguistic elements from an input text, the plurality of atomic linguistic elements including at least one linguistic element kind selected from a word, a phrase, a pattern and a lexical dependency tree;
for each atomic linguistic element, selecting at least one atomic paraphrasing element, wherein the atomic linguistic element relates to the selected at least one atomic paraphrasing element through an atomic transformation to form a candidate atomic paraphrasing pair;
obtaining a probability value of each candidate atomic paraphrasing pair;
computing a composite paraphrasing score of a combination of candidate atomic paraphrasing pairs based on the probability values of the candidate atomic paraphrasing pairs;
selecting the combination of candidate atomic paraphrasing pairs if the respective composite paraphrasing score satisfies a preset condition; and
constructing a paraphrasing text using the atomic paraphrasing elements in the selected combination of candidate atomic paraphrasing pairs.

12. The method as recited in claim 11, wherein the at least one atomic paraphrasing element of each atomic linguistic element is selected from a data source based on a probability model, wherein the atomic transformation between the atomic linguistic element and the respective at least one atomic paraphrasing element is recognized by the data source.

13. The method as recited in claim 11, wherein the probability value of each candidate atomic paraphrasing pair is obtained using an appropriate feature function of the atomic paraphrasing pair.

14. The method as recited in claim 11, wherein obtaining the probability value of each candidate atomic paraphrasing pair comprises determining a value of an appropriate feature function of the atomic paraphrasing pair; and wherein computing the composite paraphrasing score of a combination of candidate atomic paraphrasing pairs comprises computing a value of a score function which is a product of the appropriate feature functions of the candidate atomic paraphrasing pairs in the combination.

15. The method as recited in claim 11, further comprising:
forming a plurality of combinations of candidate atomic paraphrasing pairs from a plurality of candidate atomic paraphrasing pairs; and
computing the composite paraphrasing score of each of the plurality of combinations of candidate atomic paraphrasing pairs.

16. The method as recited in claim 11, wherein the atomic transformation relating each atomic linguistic element to the respective atomic paraphrasing element is selected from a group consisted of lexical substitution, active and passive exchange, reordering of sentence components, realization in different syntactic components, head omission, prepositional phrase attachment, change into different sentence types, morphological derivation, light verb construction, exchange of comparatives and superlatives, converse word substitution, verb nominalization, substitution using words with overlapping meanings, inference, and different somatic role realization.

17. The method as recited in claim 11, wherein the method is incorporated in a word processor, the input text being generated by a user, and the paraphrasing text being output to the user as an alternative to the input text.

18. The method as recited in claim 11, wherein the method is incorporated in a search engine, the input text being either generated by a user as a search query or provided by a data source as a search object, and the paraphrasing text being either used by the search engine as an alternative search query or used by the search engine as an alternative search object.

19. One or more computer readable media having stored thereupon a plurality of instructions that, when executed by a processor, causes the processor to:
select a plurality of atomic linguistic elements from an input text, the plurality of atomic linguistic elements including at least one atomic linguistic element kind selected from a word, a phrase, a pattern and a lexical dependency tree;
identify a plurality of candidate atomic paraphrasing pairs each having one of the plurality of atomic linguistic elements and an atomic paraphrasing element;
select a combination of candidate atomic paraphrasing pairs; and
construct a paraphrasing text of the input text using the atomic paraphrasing elements in the selected combination of candidate atomic paraphrasing pairs.

20. The one or more computer readable media as recited in claim 19, wherein in order to identify the plurality of candidate atomic paraphrasing pairs, the plurality of instructions, when executed by the processor, causes the processor to:
for each atomic linguistic element, select at least one atomic paraphrasing element from a data source based on a probability model, wherein the atomic linguistic element relates to the selected at least one atomic paraphrasing element through an atomic transformation recognized by the data source.
